(19) United States
(12) Patent Application Publication
(10) Pub. No.: US 2006/0102110 A1
(43) Pub. Date: May 18, 2006

(54) Cylinder block,cylinder head, and engine main body

(76) Inventors: Kazumari Takenaka, Toyota-shi (JP); Seiji Omura, Toyota-shi (JP); Toshihiro Takami, Toyota-shi (JP); Kazuya Yoshijima, Okazaki-shi (JP)

Correspondence Address: KENYON & KENYON LLP, 1500 K STREET N.W., SUITE 700, WASHINGTON, DC, 20005, US

(21) Appl. No.: 10/540,871

(22) PCT Filed: Dec. 30, 2003
(86) PCT No.: PCT/IB03/06227

§ 371 Date: Jun. 27, 2005

(30) Foreign Application Priority Data
Jan. 15, 2003 (JP) 2003-007451

(51) Int. Cl. F02F 1/24

(52) U.S. Cl. 123/41.82 A

(57) ABSTRACT

A cylinder block (10) is such that a main body cylinder block (4; 404) and an outer cylinder block (6; 406) are molded separately. As a result, the portion of the die which is used to mold a water jacket (50; 450) does not need to be made thin, thereby increasing the life of the die. Further, cylinders (12; 412) are of a simple shape and the pressure in the axial direction of the cylinder (12; 412) is able to be dispersed substantially evenly between the cylinders (12; 412) and the outer cylinder block (6; 406), thus enabling the cylinders (12; 412) to be thin. Accordingly, there is an increased degree of freedom in design of the portion which forms the water jacket (50; 450). The water jacket (50; 450) and the cylinders (12; 412) can therefore both be made sufficiently thin, thereby contributing to a decrease in both the size and weight of the engine.

### BACKGROUND OF THE INVENTION

1. Field of the Invention

The invention relates to a cylinder block, cylinder head, and engine main body of an engine.

2. Description of the Related Art

In a cylinder block of a gasoline engine or a diesel engine or the like, a water jacket for circulating coolant is formed around cylinders. As one example of a cylinder block construction in which a water jacket is formed around cylinders, Japanese Patent Laid-Open Publication No. 5-296103 (pages 2-3, FIG. 1) discloses an engine in which a cylinder wall and a water jacket wall are integrally formed and a resin casing is then mounted to the water jacket wall.

Also, Japanese Utility Model Publication SHO 63-98465 (pages 6-7, FIG. 1) discloses an engine in which a water jacket forming plate is wrapped around a cylinder uniblock in which a cylinder block and a cylinder head are integrally formed, and fixed from the outside by welding.

Further, Japanese Utility Model Publication SHO 61-76149 (pages 34, FIG. 2) discloses a cylinder block in which an end portion of a cylinder liner has a unique shape, and in which an FRP liner outer wall portion is retained under pressure between the end portion of the cylinder liner portion and a crankshaft bearing portion.

According to the art disclosed in Japanese Patent Laid-Open Publication No. 5-296103, however, when molding a water jacket in the cylinder block during casting, the portion of the die for molding the water jacket must be made thin. In particular, when sufficient cooling performance with coolant is obtained but it is not desirable to cool the cylinder more than necessary from the viewpoint of combustibility, or when considering size and weight reduction of the engine, it is necessary to mold a very thin water jacket.

Accordingly, it is necessary to make the portion of the die which forms the water jacket extremely thin. When this portion of the die is thin, however, it tends to wear and damage easily, thus shortening the life of the die. In view of this, it is therefore necessary to make the portion of the die which forms the water jacket thick. Doing so, however, results in the molding a thick, or wide, water jacket, decrease in the degree of freedom of design in the width direction, and problems such as an increase in overall size of the engine, and overcooling and overheating of the cylinders.

With the construction disclosed in Japanese Utility Model Publication SHO 63-98465 it is not necessary to provide a thin portion of the die for forming the water jacket. Rather, a thin water jacket forming plate is wrapped around a cylinder uniblock. Because the water jacket forming plate is thin, however, it tends to deform easily, which may change the width of the water jacket in the cylinder uniblock. In particular, as described above, when sufficient cooling performance with coolant is obtained but it is not desirable to cool the cylinder more than necessary from the viewpoint of combustibility, or when considering size and weight reduction of the engine, it is necessary to mold a very thin water jacket. With an extremely thin water jacket, however, even a slight deformation changes the flow of the coolant, reducing cooling performance and causing hot spots and the like which may reduce the combustion performance of the engine.

Further, with the construction disclosed in Japanese Utility Model Publication SHO 63-98465, the water jacket is formed by welding with the water jacket forming plate in the cylinder uniblock in which the cylinder block and the cylinder head are integrally formed so it can not be applied to an ordinary engine in which the cylinder block and cylinder head are separate.

The problems with the art disclosed in Japanese Patent Laid-Open Publication No. 5-296103 and Japanese Utility Model Publication SHO 63-98465 also exist when forming the water jacket in the cylinder head. With the art disclosed in Japanese Utility Model Publication SHO 61-76149, it is not necessary to provide a thin portion in the die for forming the water jacket because the FRP liner outer wall portion is provided separately. However, because the FRP liner outer wall portion is retained under pressure by the end portion of the cylinder liner portion, the cylinder liner portion is susceptible to stress that may deform the shape of the bore. Therefore, the fact that the bore is susceptible to deforming if the cylinder liner portion is made thin to reduce the size and weight of the engine may inhibit size and weight reduction of the engine.

### SUMMARY OF THE INVENTION

In view of the foregoing problems, this invention thus provides a cylinder block, cylinder head, and engine main body in an engine in which the cylinder block and the cylinder head are molded separately, which can contribute to a reduction in size and weight of the engine by increasing the degree of freedom in design of a portion which forms a water jacket.

A first aspect of the invention relates to a cylinder block in which a water jacket is formed around a cylinder, and which, combined with a separate cylinder head, forms an engine main body, the cylinder block including i) a main body cylinder block which has a mounting surface and which defines a cylinder side of the water jacket, and ii) an outer cylinder block which is molded separately from the main body cylinder block as a cylinder block portion which defines a side of the water jacket opposite the cylinder side, the outer cylinder block being arranged in a predetermined position so as to be on the mounting surface of the main body cylinder block so as to define, together with the main body cylinder block, the water jacket, the outer cylinder block to be fixed in place while pressed between the cylinder head and the main body cylinder block while arranged in the predetermined position.

According to this first aspect of the invention, the cylinder block is such that the main body cylinder block and the outer cylinder block are molded separately and sandwich the water jacket when assembled. Therefore, when molding each cylinder block portion, in particularly, when molding the cylinder block portions by casting, the portion of the die which molds the water jacket does not need to be made thin. That is, the die for the main body cylinder block need only mold the inside surface of the water jacket so the die itself can be of sufficient thickness irrespective of the actual width of the water jacket.

Similarly, with the outer cylinder block side, when casting, the die need only mold the outside surface of the water jacket so the die itself can be of sufficient thickness irrespective of the actual width of the water jacket. Because the outer cylinder block is on the other side of the water jacket from the main body cylinder block in which the cylinder is formed, the outer cylinder block does not need to be as durable as the main body cylinder block with respect to heat or wear. Therefore, the outer cylinder block does not need to be cast, which obviates the problems with respect to die durability.

Therefore, even if the width of the water jacket is designed to be narrow, the life of the die will not be reduced. Moreover, the end of the cylinder portion of the main body cylinder block bears the pressure from the cylinder head in the axial direction, but that pressure is also distributed to the outer cylinder block. As a result, the end of the cylinder portion does not need to have a complex shape. Also, even if the wall of the cylinder portion is thin, the bore itself will not deform. Further, because the outer cylinder block is molded as a cylinder block portion, it resists deformation from external force, which prevents deformation of the coolant passage of the water jacket on the inside due to external force.

As a result, the degree of freedom in design of the portion forming the water jacket is increased. Accordingly, as described above, the water jacket and the cylinder portion can be made sufficiently thin, thus contributing a reduction in size and weight of the engine.

In the first aspect of the invention, a positioning portion for determining a mounting position of the outer cylinder block with respect to the main body cylinder block may be formed on at least one of the main body cylinder block and the outer cylinder block. As a result, the main body cylinder block and the outer cylinder block can be quickly and correctly fit together to form the cylinder block.

Also, the outer cylinder block may be formed of resin or resin composite. That is, because the outer cylinder block is separated by the water jacket from the main body cylinder block in which the cylinder is formed, the outer cylinder block does not need to be as durable as the main body cylinder block with respect to heat or wear. Therefore, by forming the outer cylinder block out of resin or resin composite, it is possible to further reduce the weight and cost of the engine.

Also, for the reason stated above, a wide range of material can be used to form the outer cylinder block. Accordingly, the outer cylinder block may be formed of one or two or more materials selected from the group consisting of an aluminum alloy, a magnesium alloy, a resin, a resin composite, and a ceramic.

Also, the main body cylinder block may be molded by casting using an aluminum alloy or a magnesium alloy. As a result, the weight of the engine can be reduced even more.

Also, the main body cylinder block may have a cylinder liner cast into a bore portion of the main body cylinder block. As a result, a thin cylinder liner can be used. Typically a cylinder liner is made of a wear-resistant material such as an iron alloy which has a higher specific gravity than an aluminum alloy or a magnesium alloy, so by making the cylinder liner thin, the weight of the engine is able to be reduced.

Also, a bore portion of the main body cylinder block may be treated so as to be wear-resistant. Accordingly, because a cylinder liner does not need to be cast into the main body cylinder block, the weight of the engine is able to be reduced even more.

A second aspect of the invention relates to a cylinder head in which a water jacket is formed around a cylinder top portion, and which, combined with a separate cylinder block, forms an engine main body, the cylinder head including i) a main body cylinder head which has a mounting surface and which defines a cylinder top portion side of the water jacket; and ii) an outer cylinder head which is molded separately from the main body cylinder head as a cylinder head portion which defines a side of the water jacket opposite the cylinder top portion side, the outer cylinder head being arranged on the mounting surface of the main body cylinder head so as to define, together with the main body cylinder head, the water jacket, the outer cylinder head to be fixed in place while pressed between the cylinder block and the main body cylinder head while arranged on the mounting surface of the main body cylinder head so as to define, together with the main body cylinder head, the water jacket.

According to this second aspect of the invention, the cylinder head is such that the main body cylinder head and the outer cylinder head are molded separately and sandwich the water jacket when assembled. Therefore, when molding each cylinder head portion, in particularly, when molding the cylinder head portions by casting, the portion of the die which molds the water jacket does not need to be made thin. That is, the die for the main body cylinder head need only mold the inside surface of the water jacket so the die itself can be of sufficient thickness irrespective of the actual width of the water jacket.

Similarly, with the outer cylinder head side, when casting, the die need only mold the outside surface of the water jacket so the die itself can be of sufficient thickness irrespective of the actual width of the water jacket. Because the outer cylinder head is on the other side of the water jacket from the main body cylinder head in which the cylinder top portion is formed, the outer cylinder head does not need to be as durable as the main body cylinder head with respect to heat or wear. Therefore, the outer cylinder head does not need to be cast, which obviates the problems with respect to die durability.

Therefore, even if the width of the water jacket is designed to be narrow, the life of the die will not be reduced. Moreover, the end of the cylinder top portion of the main body cylinder head bears the pressure from the cylinder block in the axial direction, but that pressure is also distributed to the outer cylinder head. As a result, the end of the cylinder top portion does not need to have a complex shape. Also, even if the wall of the cylinder top portion is thin, the cylinder top portion itself will not deform. Further, because the outer cylinder head is molded as a cylinder head portion, it resists deformation from external force, which prevents deformation of the coolant passage of the water jacket on the inside due to external force.

As a result, the degree of freedom in design of the portion forming the water jacket is increased. Accordingly, as described above, the water jacket and the cylinder top portion can be made sufficiently thin, thus contributing a reduction in size and weight of the engine.

In the second aspect of the invention, a positioning portion for determining a mounting position of the outer cylinder head with respect to the main body cylinder head may be formed on at least one of the main body cylinder head and the outer cylinder head. As a result, the main body cylinder head and the outer cylinder head can be quickly and correctly fit together to form the cylinder head.

Also, the outer cylinder head may be formed of resin or resin composite. That is, because the outer cylinder head is separated by the water jacket from the main body cylinder head in which the cylinder top portion is formed, the outer cylinder head does not need to be as durable as the main body cylinder head with respect to heat or wear. Therefore, by forming the outer cylinder head out of resin or resin composite, it is possible to further reduce the weight and cost of the engine.

Also, for the reason stated above, a wide range of material can be used to form the outer cylinder head. Accordingly, the outer cylinder head may be formed of one or two or more materials selected from the group consisting of an aluminum alloy, a magnesium alloy, a resin, a resin composite, and a ceramic.

Also, the main body cylinder head may be molded by casting using an aluminum alloy or a magnesium alloy. As a result, the weight of the engine can be reduced even more.

A third aspect of the invention relates to an engine main body which includes a cylinder block in which a water jacket is formed around a cylinder, and a cylinder head in which the water jacket is formed around a cylinder top portion, the engine main body including i) a main body cylinder block which has a mounting surface and which defines a cylinder side of the water jacket; ii) a main body cylinder head which forms a cylinder top portion side of the water jacket; and iii) an outer cylinder block which is molded separately from the main body cylinder block and the main body cylinder head as a cylinder block portion which defines a side of the water jacket opposite the cylinder side and the cylinder top portion side, the outer cylinder block being arranged in a predetermined position so as to be between the mounting surface of the main body cylinder block and the mounting surface of the main body cylinder head so as to define, together with the main body cylinder block and the main body cylinder head, the water jacket, the outer cylinder block being fixed in place while pressed between the main body cylinder block and the main body cylinder head while arranged in the predetermined position.

According to this third aspect of the invention, the engine main body is such that the main body cylinder block, the main body cylinder head, and the outer cylinder block are molded separately and sandwich the water jacket when assembled. Therefore, when molding each portion, in particularly, when molding the each portion by casting, the portion of the die which molds the water jacket does not need to be made thin. That is, the die for the main body cylinder block and the main body cylinder head need only mold the inside surface of the water jacket so the die itself can be of sufficient thickness irrespective of the actual width of the water jacket.

Similarly, with the outer cylinder block side, when casting, the die need only mold the outside surface of the water jacket so the die itself can be of sufficient thickness irrespective of the actual width of the water jacket. Because the outer cylinder block is on the other side of the water jacket from the main body cylinder block and the main body cylinder head which form the cylinder and the cylinder top portion, the outer cylinder block does not need to be as durable as the main body cylinder block and the main body cylinder head with respect to heat or wear. Therefore, the outer cylinder block does not need to depend on casting, which obviates the problems with respect to die durability.

Therefore, even if the width of the water jacket is designed to be narrow, the life of the die will not be reduced. Moreover, the ends of the cylinder of the main body cylinder block and the cylinder top portion of the main body cylinder head each bear the pressure from the other in the axial direction, but that pressure is also distributed to the outer cylinder block. As a result, the end of the cylinder and the end of the cylinder top portion do not need to have a complex shape. Also, even if the wall of the cylinder and the cylinder top portion is thin, the bore itself will not deform. Further, because the outer cylinder block is molded as a cylinder block portion, it resists deformation from external force, which prevents deformation of the coolant passage of the water jacket on the inside due to external force.

As a result, providing the outer cylinder block increases the degree of freedom in design on the main body cylinder block side and the main body cylinder head side which together form the water jacket. Accordingly, as described above, the water jacket, cylinder, or cylinder top portion can be made sufficiently thin, thus contributing a reduction in size and weight of the engine.

In the third aspect of the invention, a positioning portion for determining a mounting position of the outer cylinder block with respect to the main body cylinder block may be formed on at least one of the main body cylinder block and the outer cylinder block. As a result, the main body cylinder block and the outer cylinder block can be quickly and correctly fit together to form the cylinder block. Further, the engine main body can be formed by fixing the outer cylinder block in place while pressed between the main body cylinder block and the main body cylinder head.

Also, the outer cylinder block may be formed of resin or resin composite. That is, because the outer cylinder block is separated by the water jacket from the main body cylinder block and the main body cylinder head which form the cylinder and the cylinder top portion, the outer cylinder block does not need to be as durable as the main body cylinder block and the main body cylinder head with respect to heat or wear. Therefore, by forming the outer cylinder block out of resin or resin composite, it is possible to further reduce the weight and cost of the engine.

Also, for the reason stated above, a wide range of material can be used to form the outer cylinder block. Accordingly, the outer cylinder block may be formed of one or two or more materials selected from the group consisting of an aluminum alloy, a magnesium alloy, a resin, a resin composite, and a ceramic.

Also, the main body cylinder block may be molded by casting using an aluminum alloy or a magnesium alloy. As a result, the weight of the engine can be reduced even more.

Also, the main body cylinder block may have a cylinder liner cast into a bore portion of the main body cylinder block. As a result, a thin cylinder liner can be used. Typically a cylinder liner is made of a wear-resistant material such as an iron alloy which has a higher specific gravity than an aluminum alloy or a magnesium alloy, so by making the cylinder liner thin, the weight of the engine is able to be reduced.

Also, a bore portion of the main body cylinder block may be treated so as to be wear-resistant. Accordingly, because a cylinder liner does not need to be cast into the main body cylinder block, the weight of the engine is able to be reduced even more.

Also, the main body cylinder head may be molded by casting using an aluminum alloy or a magnesium alloy. As a result, the weight of the engine can be reduced further.

Also, the outer cylinder block may be fastened in place between the main body cylinder head and the main body cylinder block with a fastening bolt. As a result, the outer cylinder block is fixed in place while pressed between the main body cylinder head and the main body cylinder block.

A fourth aspect of the invention relates to an engine main body that uses any one of the cylinder blocks according to the first aspect of the invention and a cylinder head, with the outer cylinder block fixed between the main body cylinder block of the cylinder block and the cylinder head with a fastening bolt. As a result, the engine main body is formed with the outer cylinder block fixed in place while pressed between the cylinder head and the main body cylinder block.

Also, a sealing material or welding may be used to seal between the main body cylinder block and the outer cylinder block. Using this construction prevents coolant from leaking from the water jacket.

A fifth aspect of the invention relates to an engine main body that uses any one of the cylinder heads according to the second aspect of the invention and a cylinder block, with the outer cylinder block fixed between the cylinder block and the cylinder head of the main body cylinder head with a fastening bolt. As a result, the engine main body is formed with the outer cylinder block fixed in place while pressed between the main body cylinder head and the cylinder block.

Also, a sealing material or welding may be used to seal between the main body cylinder head and the outer cylinder head. Using this construction prevents coolant from leaking from the water jacket.

A sixth exemplary embodiment of the invention relates to an engine main body which includes a cylinder block in which a water jacket is formed around a cylinder, and a cylinder head in which the water jacket is formed around a cylinder top portion, the engine main body including i) a cylinder block which defines a cylinder side of the water jacket; ii) a main body cylinder head which has a mounting surface and which defines the cylinder top portion side of the water jacket; and iii) an outer cylinder head which is molded separately from the main body cylinder head as a cylinder head portion which defines a side of the water jacket opposite the cylinder side, the outer cylinder head being arranged in a predetermined position so as to be on the mounting surface of the main body cylinder head so as to define, together with the main body cylinder block and the main body cylinder head, the water jacket, the outer cylinder head being fixed in place while pressed between the cylinder block and the main body cylinder head while arranged in the predetermined position.

### BRIEF DESCRIPTION OF THE DRAWINGS

FIG. 1 is a perspective view showing an engine main body according to one exemplary embodiment of the invention.

FIG. 2 is an exploded perspective view of the engine main body.

FIG. 3 is a perspective view of a cylinder block according to the first exemplary embodiment of the invention.

FIG. 4 is a plan view of the cylinder block.

FIG. 5 is a plan view of a main body cylinder block according to the first exemplary embodiment of the invention.

FIG. 6 is a partially fractured perspective view of the main body cylinder block.

FIG. 7A a perspective view of an outer cylinder block according to the first exemplary embodiment of the invention, and FIG. 7B a perspective view of the outer cylinder block upside down.

FIG. 8A is a plan view of the outer cylinder block, FIG. 8B is a front view of the outer cylinder block, FIG. 8C is a bottom view of the outer cylinder block, and FIG. 8D is a right side view of the outer cylinder block.

FIG. 9 is a partially fractured perspective view of the outer cylinder block.

FIG. 10 is a sectional view of the cylinder block cut along the axis of one of the cylinders.

FIG. 11 is a partially fractured perspective view of the engine main body cut between two of the cylinders.

FIG. 12 is a perspective view showing a cylinder block according to a second exemplary embodiment of the invention.

FIG. 13 is a partially fractured perspective view of an engine main body according to the second exemplary embodiment of the invention, cut between the cylinders.

FIG. 14 is a sectional view showing the engine main body cut along the axis of one of the cylinders.

FIG. 15 is a sectional view of an engine main body according to a third exemplary embodiment of the invention, cut along the axis of one of the cylinders.

FIG. 16 is a sectional view of an engine main body according to a fourth exemplary embodiment of the invention, cut along the axis of one of the cylinders.

FIG. 17A is a sectional view showing one example of a seal construction in which a tapered surface is provided on the bottom surface of the outer cylinder block, and FIG. 17B is an explanatory view illustrating the state a liquid sealing material retained on the tapered surface of the outer cylinder block shown in FIG. 17A.

FIG. 18A is a sectional view illustrating one example of a modified shape of the mounting surface of the main body cylinder block or the main body cylinder head and the bottom surface of the outer cylinder block or the outer cylinder head, and FIG. 18B is an explanatory view illustrating the main body cylinder head mounted to the main body cylinder block shown in FIG. 18A.

FIG. 19 is a sectional view showing an example of a closed deck.

### DETAILED DESCRIPTION OF THE PREFERRED EMBODIMENTS

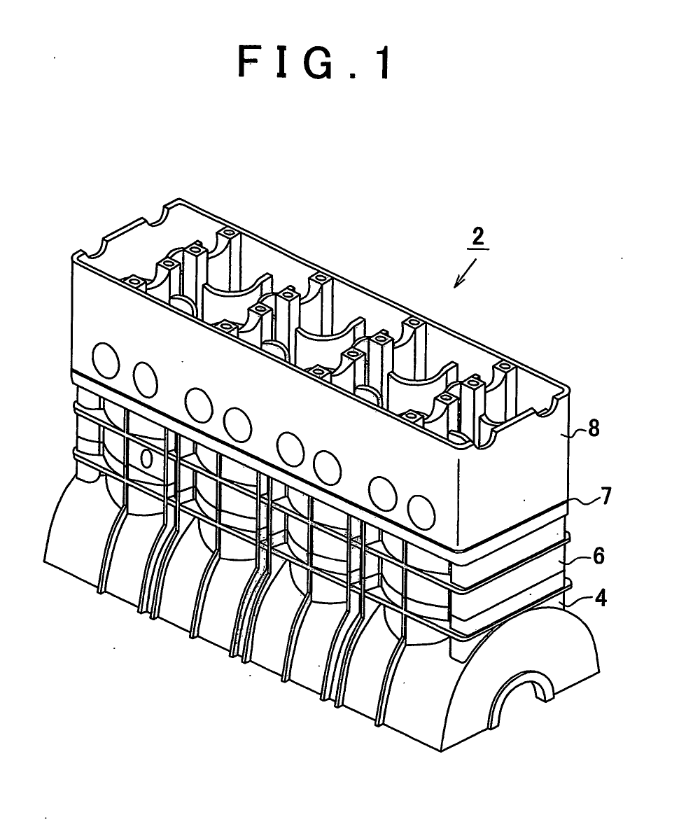

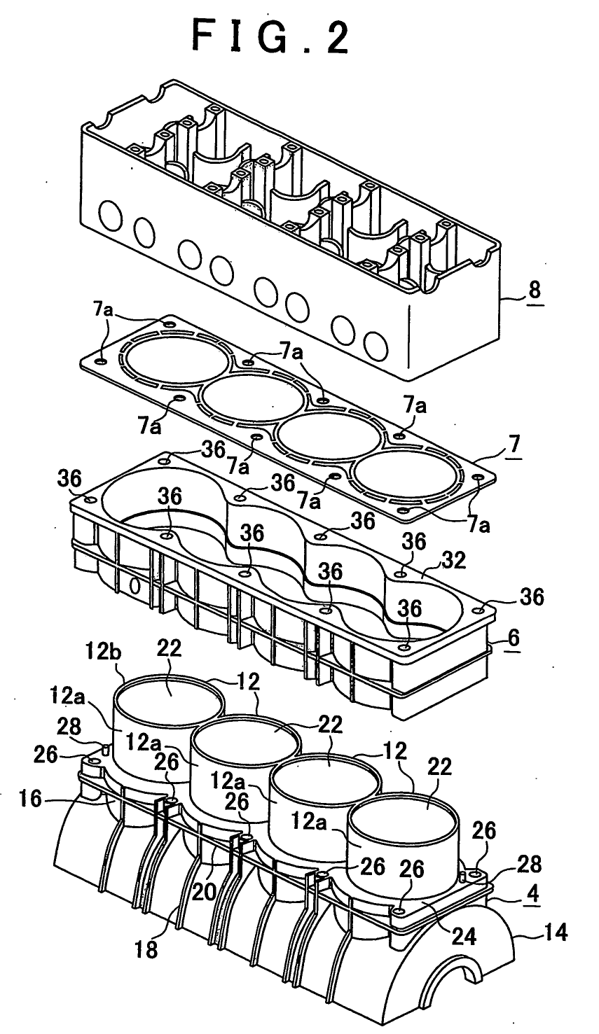

As a first exemplary embodiment of the invention, the perspective view of FIG. 1 shows the construction of an engine main body 2 of a four cylinder internal combustion engine to which the invention may be applied. This engine main body 2 is constructed by stacking a main body cylinder block 4, an outer cylinder block 6, a gasket 7, and a cylinder head 8 together, as shown in the exploded perspective view of FIG. 2.

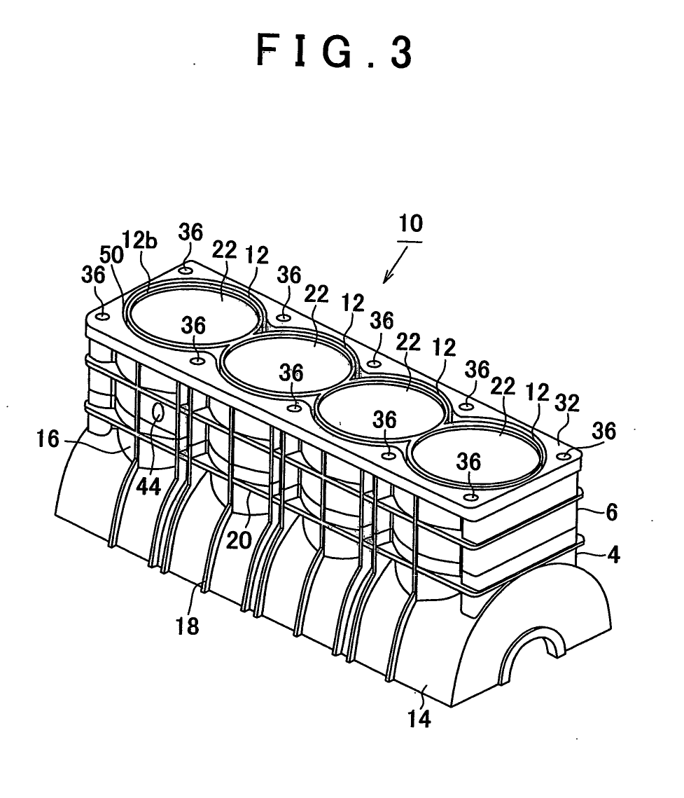

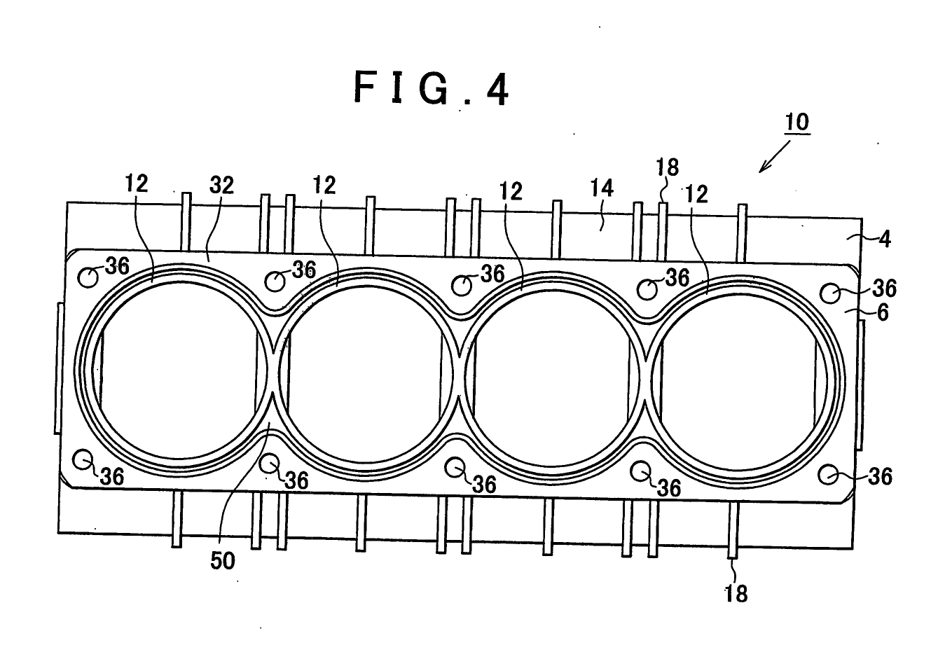

The main body cylinder block 4 and the outer cylinder block 6 are fit together, as shown in the perspective view of FIG. 3 and the plan view of FIG. 4, so as to form a cylinder block 10.

The main body cylinder block 4 is integrally cast from an aluminum alloy or a magnesium alloy. The main body cylinder block 4 includes four cylindrical cylinders 12 formed at an upper portion, a skirt 14 formed at a lower portion, and an outer wall mounting portion 16 formed between the cylinders 12 and the skirt 14. A plurality of ribs 18 and 20 are provided on the outside of the skirt 14 and outer wall mounting portion 16 for added strength.

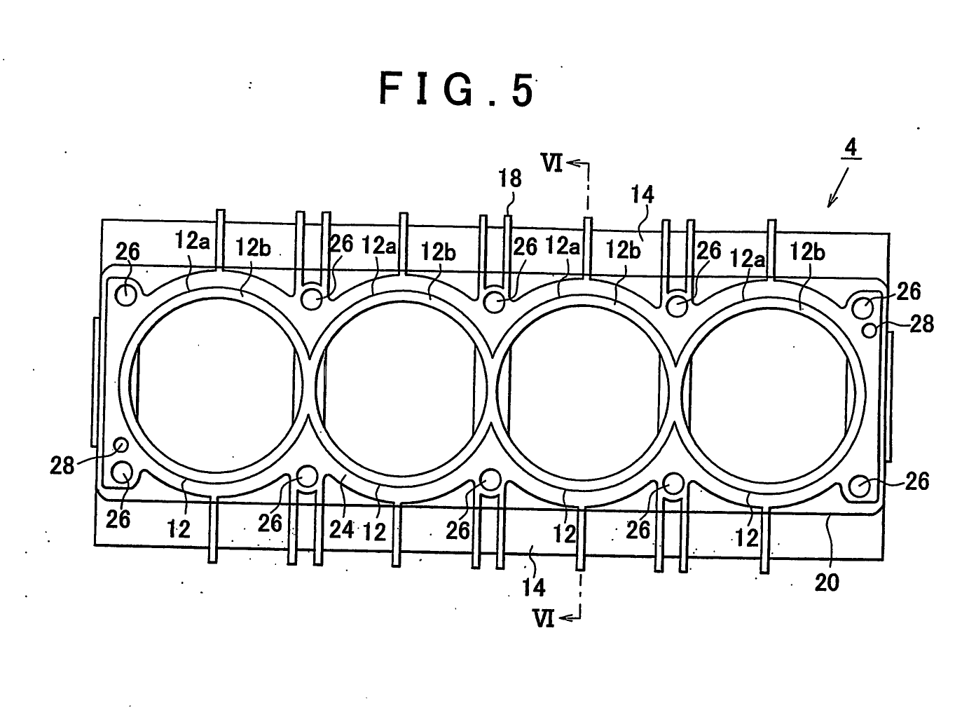

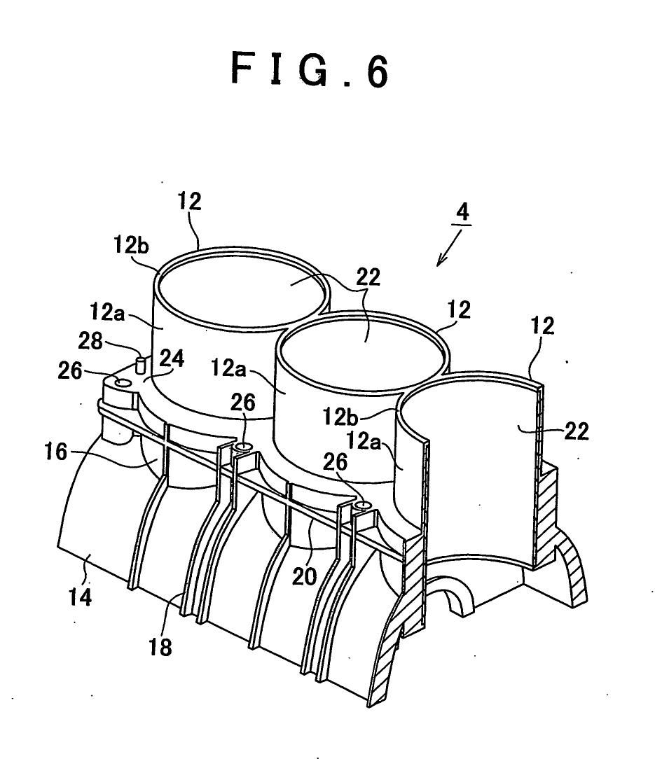

As shown in the plan view of FIG. 5 and the sectional perspective view of FIG. 6 (cut along line VI-VI in FIG. 5), a cylinder liner 22 (made of an iron alloy in this exemplary embodiment) is cast into a portion forming a bore on the inner peripheral side of each cylinder 12. A mounting surface 24 is formed around all of the cylinders 12 on the outer wall mounting portion 16. This mounting surface is perpendicular to the width direction of the cylinders 12. Further, bolt screw holes 26 are provided in ten locations in the mounting surface 24 around the cylinders 12. In addition, protruding knock pins 28 are provided at two locations diagonal from each other on the mounting surface 24 for positioning the outer cylinder block 6.

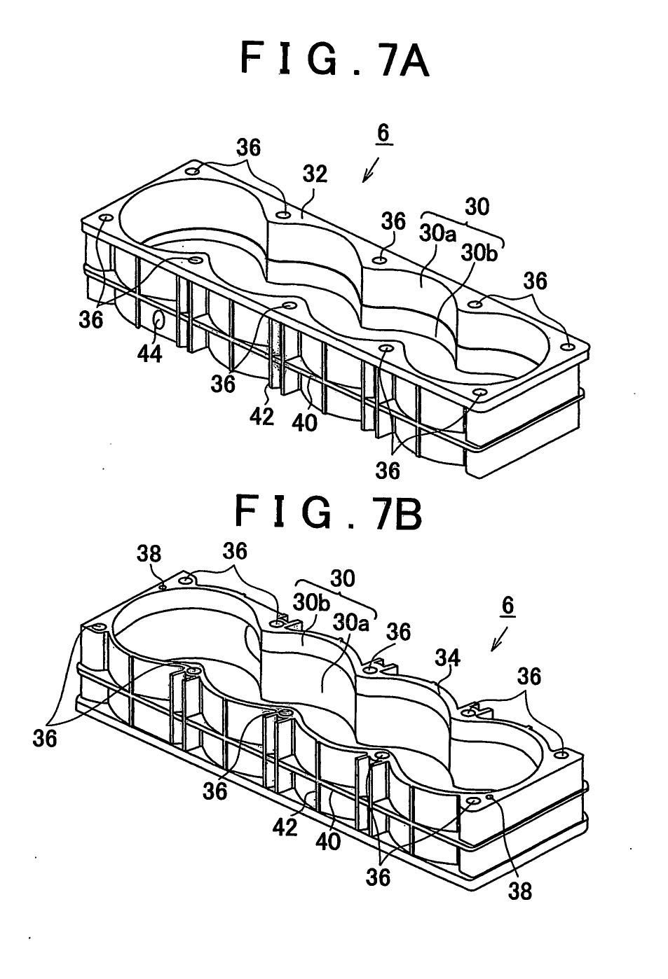

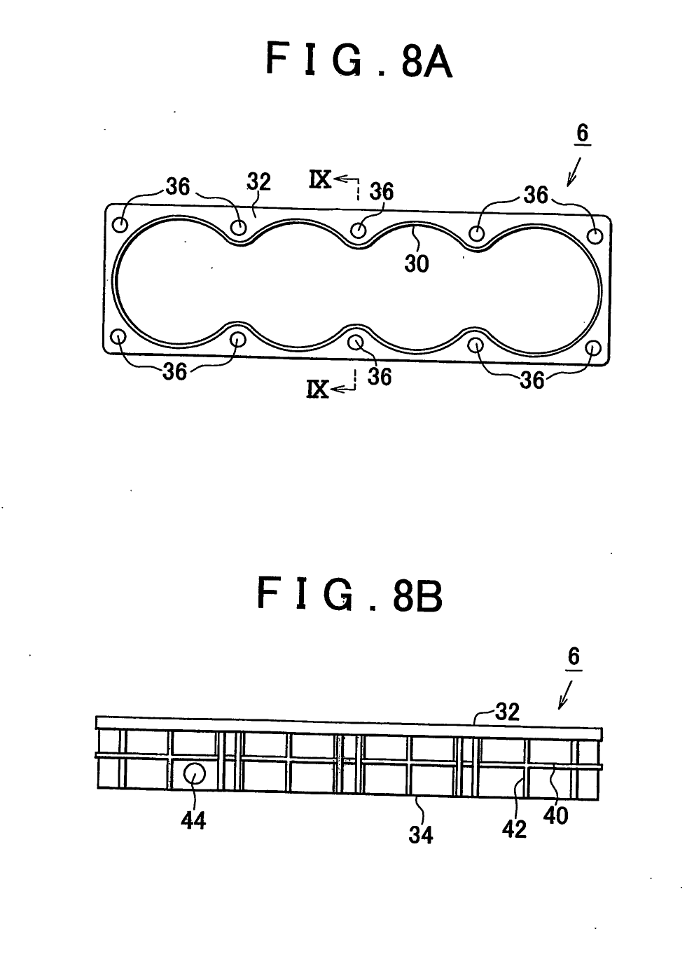

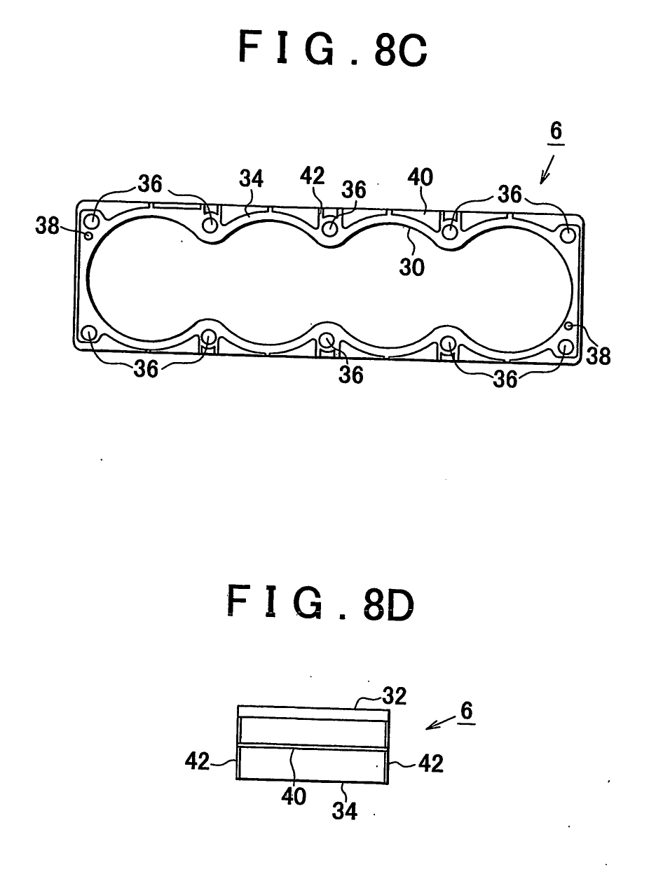

A perspective view of the outer cylinder block 6 is given in FIG. 7A and FIG. 7B, and four sides of the outer cylinder block 6 are shown in FIGS. 8A to 8D. FIG. 7A is a normal perspective view and FIG. 7B is a perspective view showing the outer cylinder block 6 upside down. Also, FIG. 8A is a plan view, FIG. 8B is a front view, FIG. 8C is a bottom view, and FIG. 8D is a right side view. In this exemplary embodiment the outer cylinder block 6 is a molded body of resin or resin composite (such as resin strengthened by fiber such as glass fiber or carbon fiber). Alternatively, the outer cylinder block 6 may be integrally molded of an aluminum alloy, a magnesium alloy, or a ceramic.

The outer cylinder block 6 is molded in a circular shape having an inner peripheral surface 30 corresponding to an outer peripheral surface 12a of the cylinders 12 shown in FIG. 6. This inner peripheral surface 30 includes an upper inner peripheral surface 30a and a lower inner peripheral surface 30b. The lower inner peripheral surface 30b is molded so that it is closer than the upper inner peripheral surface 30a to the outer peripheral surface 12a of the cylinders 12.

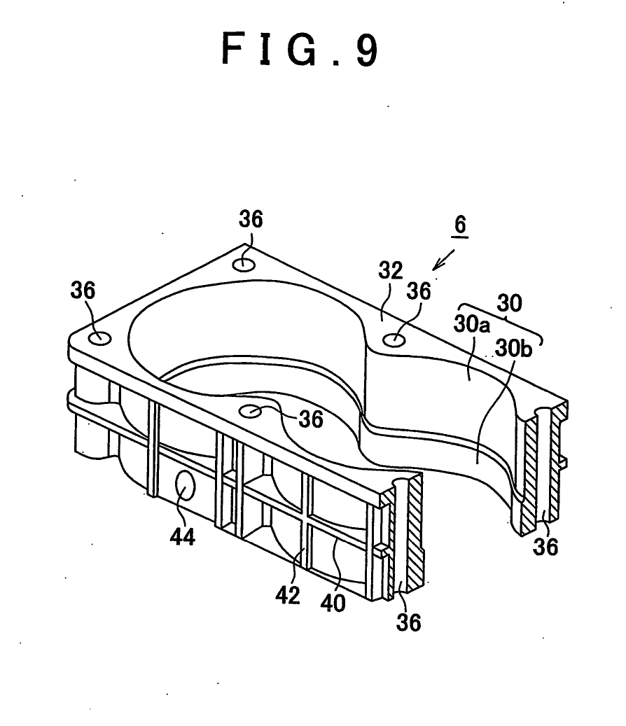

A flat outer peripheral deck face 32 is formed on the top end of the outer cylinder block 6 and a bottom surface 34 is formed on the bottom end of the outer cylinder block 6. Bolt through-holes 36 are provided in ten locations in the axial direction of the inner peripheral surface 30, which extend from the outer peripheral deck face 32 through to the bottom surface 34, as shown in the sectional perspective view of FIG. 9 (cross-section IX-IX in FIG. 8A). The locations of these bolt through-holes 36 corresponds to the ten bolt screw holes 26 provided in the main body cylinder block 4. Further, positioning holes 38 into which the knock pins 28 provided on the main body cylinder block 4 side are inserted are provided in the bottom surface 34 in locations corresponding to the knock pins 28 on the main body cylinder block 4 side. The knock pins 28 and the positioning holes 38 together correspond to a positioning portion. A metal sleeve may also be provided in the bolt through-holes 36.

A plurality of ribs 40 and 42, as well as a coolant port 44 which allows coolant to flow into and out of the water jacket, are provided around the outer cylinder block 6.

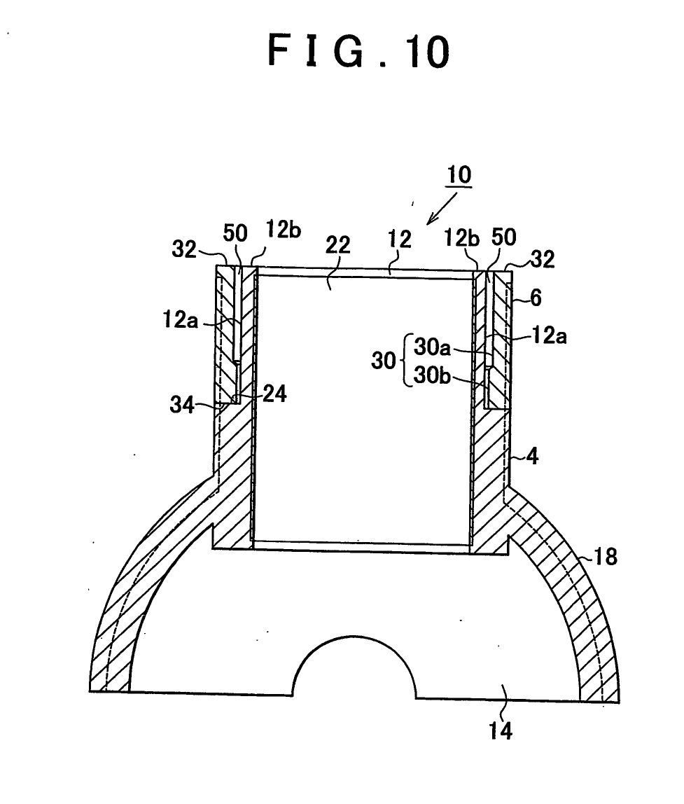

According to this construction, the main body cylinder block 4 and the outer cylinder block 6 are fit together in correct alignment by the knock pins 28 on the main body cylinder block 4 side and the positioning holes 38 on the outer cylinder block 6 side, as shown in FIG. 3. When they are assembled in this way, a water jacket 50 is formed between the outer peripheral surface 12a of the cylinders 12 in the main body cylinder block 4 and the inner peripheral surface 30 of the outer cylinder block 6, as shown in FIG. 10. At this time, the width of the water jacket 50 is wider on the upper inner peripheral surface 30a side of the inner peripheral surface 30 of the outer cylinder block 6 than on the lower inner peripheral surface 30b side thereof. An inner peripheral deck face 12b on the upper end of the cylinders 12 in the main body cylinder block 4 and the outer peripheral deck face 32 on the upper end of the outer cylinder block 6 are level or almost level.

A liquid sealing material (such as a silicon sealing material) is applied beforehand to one or both of the bottom surface 34 of the main body cylinder block 4 and the bottom surface 34 of the outer cylinder block 6. As a result, between the main body cylinder block 4 and the outer cylinder block 6 is sealed to prevent coolant from leaking from the water jacket 50. Alternatively, a gasket may be used instead of the liquid sealing material. Also, when the outer cylinder block 6 is made of a metal such as an aluminium alloy or an magnesium alloy, welding (e.g., TIG welding, MIG welding, laser welding, friction (agitation) welding) may also be used for the purpose of providing a seal. That is, a boundary portion of the main body cylinder block 4 and the outer cylinder block 6 may be welded together from the outside while the mounting surface 24 of the main body cylinder block 4 and the bottom surface 34 of the outer cylinder block 6 are in contact with one another, as shown in FIG. 10.

After the inner peripheral deck face 12b and the outer peripheral deck face 32 have been machined, the cylinder head 8 is fit on the cylinder block 10 which is an assembly of the main body cylinder block 4 and the outer cylinder block 6, as shown in FIG. 3, with a gasket 7 sandwiched in between.

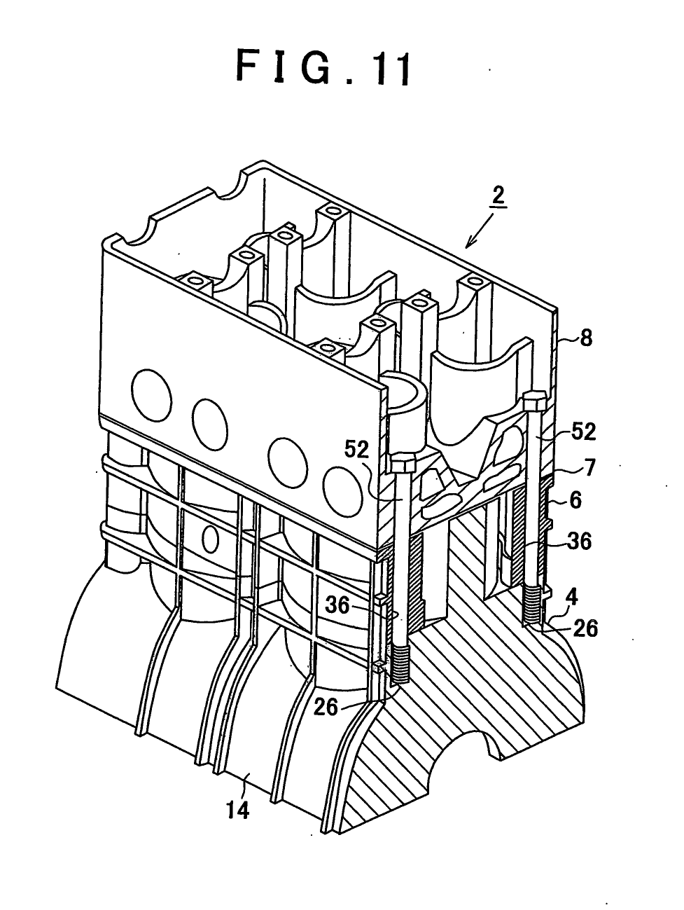

As shown in the longitudinal sectional perspective view of FIG. 11, ten fastening bolts 52 are screwed from the cylinder head 8 into the bolt screw holes 26 in the main body cylinder block 4 via bolt through-holes 7a in the gasket 7 and the bolt through-holes 36 in the outer cylinder block 6. The outer cylinder block 6 is thereby secured in place while receiving pressure from both the cylinder head 8 and the main body cylinder block 4. Accordingly, the main body cylinder block 4, the outer cylinder block 6, and the cylinder head 8 are able to be integrally as the engine main body 2, as shown in FIG. 1.

The effects achieved by the exemplary embodiment described above will hereinafter be described.

(1A) The cylinder block 10 is such that the main body cylinder block 4 and the outer cylinder block 6 are molded separately.

When the cylinder block 10, as shown in FIGS. 3, 4, and 10, is molded by casting as a single unit, as with conventional art, the portion of the die which forms the water jacket 50 is long and extremely thin. When repeatedly used for casting, this portion tends to wear and become damaged, severely shortening the life of the die.

In this exemplary embodiment of the invention, however, the cylinder block 10 is can be formed with the main body cylinder block 4 and the outer cylinder block 6 molded separately and arranged so as to sandwich the water jacket 50. Therefore, when molding each block 4 and 6, in particularly, when molding the main body cylinder block 4 by casting, the portion of the die which molds the water jacket 50 does not need to be made thin. That is, the die for the main body cylinder block 4 need only mold the inside surface of the water jacket 50 so the die itself can be of sufficient thickness irrespective of the actual width of the water jacket 50, thereby increasing the life of the die.

Similarly, in this exemplary embodiment of the invention, the outer cylinder block 6 is molded of resin or resin composite. However, in this case, durability of the die is not a problem. In particular, casting the outer cylinder block 6 with a metal such as an aluminum alloy or an magnesium is similar to casting the main body cylinder block 4. That is, the die need only mold the outside surface of the water jacket 50 so the die itself can be of sufficient thickness irrespective of the actual width of the water jacket 50, thereby increasing the life of the die.

Moreover, the ends of the cylinders 12 of the main body cylinder block 4 bear the pressure from the cylinder head 8 in the axial direction, but that pressure is also distributed to the outer cylinder block 6. As a result, the ends of the cylinders 12 need only bear the pressure from the cylinder head 8 and therefore do not need to have a complex shape. Also, even if the walls of the cylinders 12 are thin, the bores themselves will not deform. Further, because the outer cylinder block 6 is molded as a cylinder block portion, it resists deformation from external force, which prevents deformation of the coolant passage of the water jacket 50 on the inside due to external force.

As a result, the degree of freedom in design of the portion forming the water jacket 50 is increased. Accordingly, as described above, the water jacket 50 and the cylinders 12 can be made sufficiently thin, thus contributing a reduction in size and weight of the engine.

(1B) Providing the knock pins 28 and the positioning holes 38 enables the outer cylinder block 6 to be correctly arranged on the main body cylinder block 4 by simply placing the outer cylinder block 6 on the mounting surface 24 of the main body cylinder block 4.

(1C) Because the outer cylinder block 6 is separated by the water jacket 50 from the main body cylinder block 4 in which the cylinders 12 are formed, the outer cylinder block 6 does not need to be as durable as the main body cylinder block 4 with respect to heat or wear. Therefore, the outer cylinder block 6 is formed out of resin or resin composite, which enables a further reduction in weight and cost of the engine.

The outer cylinder block 6 is fixed in place while pressed between the mounting surface 24 of the main body cylinder block 4 and the cylinder head 8, but the fastening force is also distributed to the cylinders 12. As a result, even if the outer cylinder block 6 is made of resin, it resists deformation and therefore is able to keep the water jacket 50 water tight.

(1D) As described above, the main body cylinder block 4 is cast separately from the outer cylinder block 6, so the inner portion of the die does not need to have a complex shape. Furthermore, the inner peripheral deck face 12b of the cylinders 12 need only fit tightly against the bottom face of the cylinder head 8 via the gasket 7, and the cylinders 12 are not of a complex shape but are instead of a simple cylindrical shape, thus further simplifying the inner portion of the die.

As a result, molten medal pours smoothly into the die during casting so cavities tend not to form in the cast, which improves the manufacturing yield rate and lowers manufacturing costs. Further, with the cast of the outer cylinder block 6 as well, because the outer cylinder block 6 is cast separately from the main body cylinder block 4, the inner portion of the die does not need to have a complex shape. As a result, molten medal pours smoothly into the die during casting so cavities tend not to form in the cast, which improves the manufacturing yield rate and lowers manufacturing costs.

(1E) The cylinders 12 have a simple cylindrical shape and the inner peripheral deck face 12b receives pressure from the cylinder head 8 in the axial direction via the gasket 7 substantially evenly around the entire periphery. As a result, as opposed to the related art, the cylinders 12 tend not to receive uneven pressure from fastening or pressure from the side which may deform the cylinders 12, or more particularly, which may deform the bores. Therefore, the bore shape can be precisely maintained and fiction and wear from a piston ring is kept from increasing. Further, because there is no decrease in air-tightness between the piston ring and the bore, the energy efficiency of the engine is able to be kept high.

With the outer cylinder block 6 as well, the outer peripheral deck face 32 receives pressure from the cylinder head 8 in the axial direction via the gasket 7 substantially evenly around the entire periphery. As a result, the outer cylinder block 6 tends not to receive uneven pressure from fastening or pressure from the side which may deform the outer cylinder block 6 so water-tightness between the main body cylinder block 4 and the cylinder head 8 is able to be maintained.

(1F) Because the main body cylinder block 4 is cast from an aluminum alloy or a magnesium alloy, the weight of the engine is able to be reduced. Also, by casting the cylinder liner 22 into the main body cylinder block 4, not only is the durability of the cylinders 12 is able to be improved, but also a cylinder liner 22 which is thin is able to be used, which contributes to a reduction in weight of the engine.

(1G) The cylinders 12 provided with the cast main body cylinder block 4 as shown in FIG. 2 are completely exposed, which facilitates various processing (such as thread machining and processing for inter-bore cooling) of the cylinders 12 from both the inner peripheral surface and the outer peripheral surface, processing of the cylinder liner 22 from the inner peripheral surface and the outer peripheral surface, and processing around the cylinders 12.

Moreover, various processing of the inner peripheral surface 30 of the outer cylinder block 6 is also facilitated. As a result, the molding of the coolant passage of the water jacket 50 is able to be done with an extremely high degree of freedom, it is easier to regulate the temperature around and between bores, and the temperature distribution around and between bores can be optimized so as to control deformation of the bore due to fastening and heat generated during combustion and therefore obtain preferable engine performance.

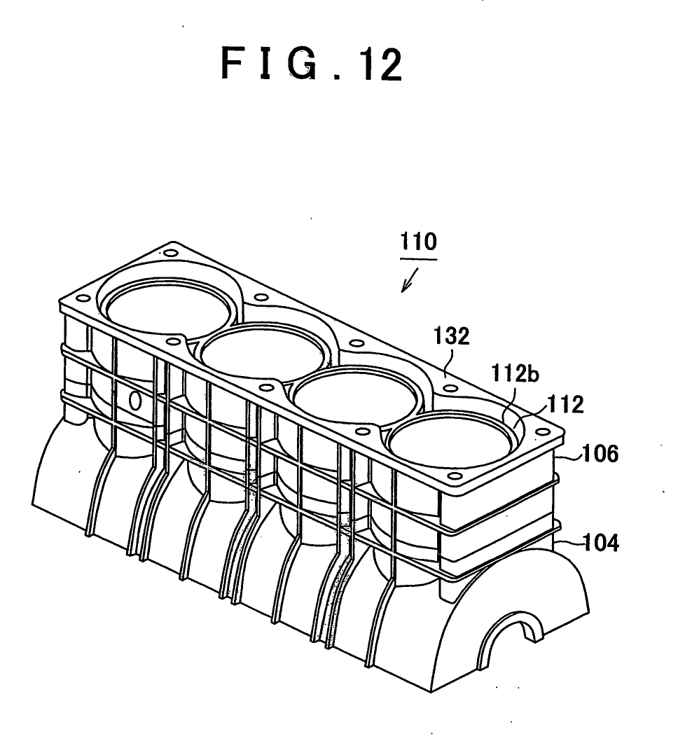

According to a second exemplary embodiment of the invention, in a cylinder block 110, a main body cylinder block 104 is similar in shape to the main body cylinder block 4 in the first exemplary embodiment of the invention, but an outer cylinder block 106 is formed higher than a cylinder 112, as shown in the perspective view of FIG. 12. As a result, when the main body cylinder block 104 and the outer cylinder block 106 are fit together, an outer peripheral deck face 132 is higher than an inner peripheral deck face 112b, as shown in the drawing.

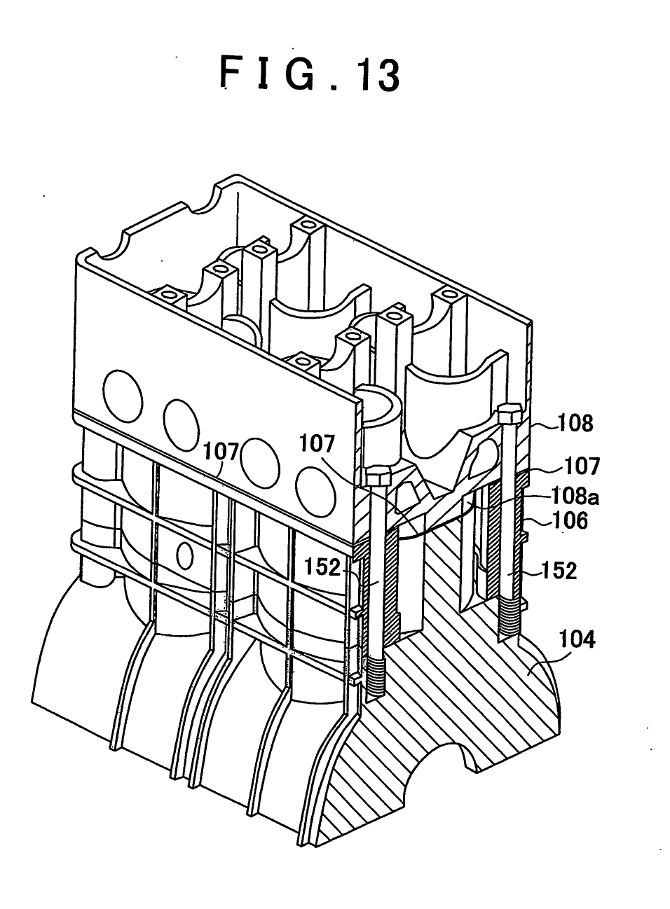

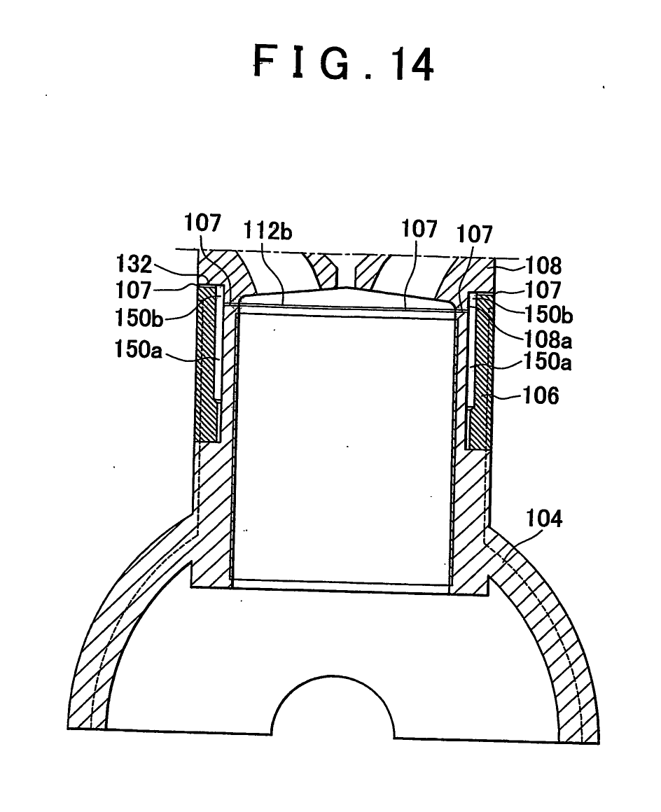

A main body cylinder head 108 is formed such that an inner wall portion 108a on the cylinder top portion side contacting the inner peripheral deck face 112b protrudes downward in a manner corresponding to the shape of the cylinder block 110, as shown in the fractured perspective view of FIG. 13 (a section between two of the cylinders 112) and the longitudinal sectional view of FIG. 14 (a section in the center of one of the cylinders 112). As a result, by fastening the outer cylinder block 106 with fastening bolts 152, the main body cylinder head 108 is able to fit tightly against the inner peripheral deck face 112b and the outer peripheral deck face 132 via a gasket 107 and make a water-tight seal.

The gasket 107 is integrally molded with a step between the inner peripheral deck face 112b and the outer peripheral deck face 132. Alternatively, however, a separate gasket may be provided for both the inner peripheral deck face 112b and the outer peripheral deck face 132.

Also, the gasket 107 may be used only at points of contact between the inner peripheral deck face 112b and the main body cylinder head 108, and the liquid sealing material described in the first exemplary embodiment of the invention may be used to seal the points of contact between the outer peripheral deck face 132 and the main body cylinder head 108.

This outer cylinder block 106 also serves as an outer wall of a water jacket 150a on the cylinder block 110 side and an outer wall of a water jacket 150b on the main body cylinder head 108 side.

The mounting position of, and sealing between, the outer cylinder block 106 and the main body cylinder block 104 are similar to those of the outer cylinder block 6 and the main body cylinder block 4 described in the first exemplary embodiment of the invention.

The effects achieved by the second exemplary embodiment described above will hereinafter be described.

(2A) Effects equivalent to the effects described in (1A) to (1G) in the first exemplary embodiment of the invention, as well as the effects with respect to the relationship between the main body cylinder head 108 and the outer cylinder block 106, are able to be achieved.

These effects are able to be achieved on both the main body cylinder block 104 side and the main body cylinder head 108 side with only one outer cylinder block 106, so the number of engine parts does not increase.

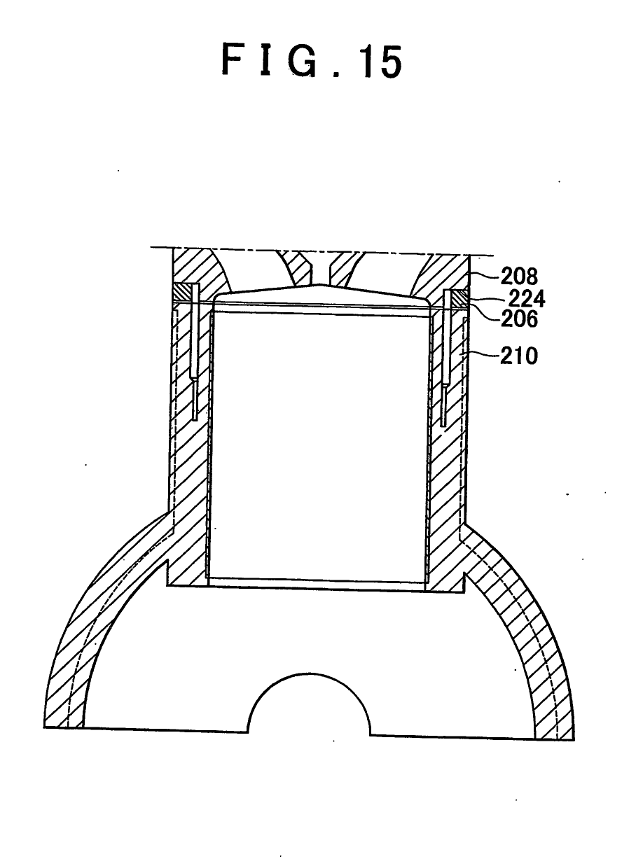

According to a third exemplary embodiment of the invention, the cylinder head is molded in two parts, one being a main body cylinder head 208 and the other being an outer cylinder head 206, as illustrated in the longitudinal sectional view of FIG. 15, which differs from the first exemplary embodiment of the invention. An entire cylinder block 210 is shown which is integrally molded, but it may also be molded in two parts, one being a main body cylinder block and the other an outer cylinder block, as in the first exemplary embodiment of the invention.

The relationship between the main body cylinder head 208 and the outer cylinder head 206 is similar to the relationship between the main body cylinder block 4 and the outer cylinder block 6 in the first exemplary embodiment of the invention. That is, the position of the outer cylinder head 206 on a mounting surface 224 of the main body cylinder head 208 is determined by knock pins and positioning holes. Also, the outer cylinder head 206 is fastened under pressure by passing fastening bolts from the main body cylinder head 208 side through bolt through-holes formed in the outer cylinder head 206 to the cylinder block 210 side.

The effects achieved by the third exemplary embodiment described above will hereinafter be described.

(3A) With the exception of the effects regarding the bore shape, effects equivalent to the effects described in (1A) to (1G) in the first exemplary embodiment of the invention, as well as effects with respect to the relationship of the main body cylinder head 208 and the outer cylinder head 206 are able to be achieved.

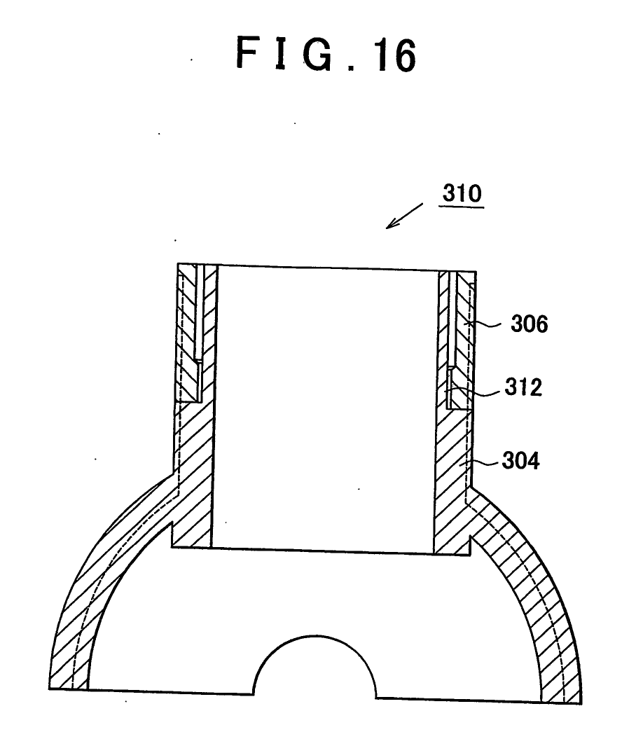

According to a fourth exemplary embodiment of the invention, a cylinder block 310 is constructed from a main body cylinder block 304 and an outer cylinder block 306, as described in the first exemplary embodiment of the invention and illustrated in the longitudinal sectional view of FIG. 16. In contrast to the first exemplary embodiment of the invention, however, a cylinder liner is not cast into a cylinder 312 of the main body cylinder block 304. Rather, the inner peripheral surface of the cylinder 312 is made of an aluminum alloy or an magnesium alloy and forms the bore. This bore portion is then surface treated by spray coating so as to make it wear resistant. The construction aside from this is the same as described in the first exemplary embodiment of the invention.

The effects achieved by the fourth exemplary embodiment described above will hereinafter be described.

(4A) The same effects as the effects described in (1A) to (1G) in the first exemplary embodiment of the invention are achieved. In particular, with the fourth exemplary embodiment defects from cavities in the inner peripheral surface of the cylinder 312 tend not to occur due to the fact that cavities tend not to form in the cast, as described in (ID) in the first exemplary embodiment of the invention. Therefore, even with the surface treatment such as spray coating, a sufficiently smooth surface is able to be formed as the bore so the yield rate increases, which in turn suppresses manufacturing costs.

(4B) Because the cylinder liner does not need to be cast into the bore portion of the main body cylinder block, the overall weight of the engine is able to be reduced.

Modified embodiments will now be described.

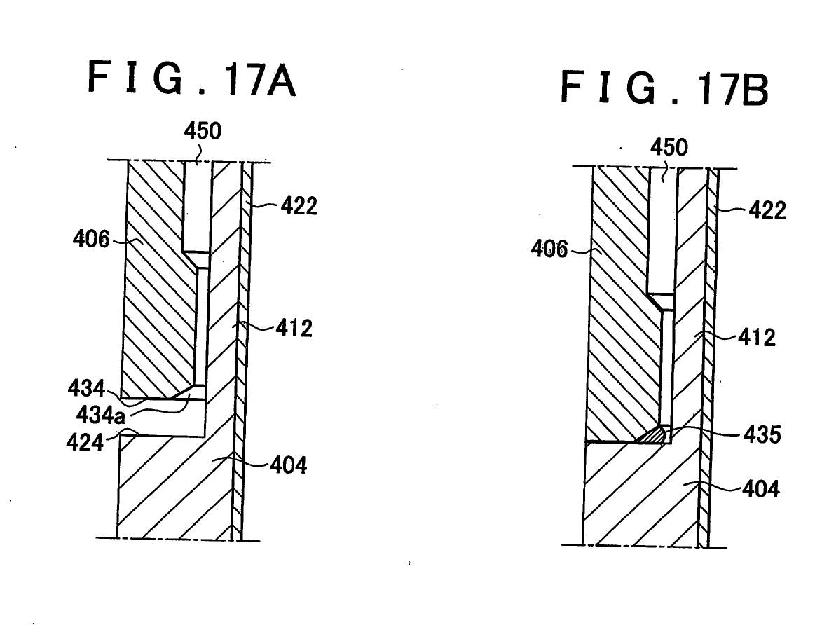

(a) In each of the exemplary embodiments, a tapered surface 434a may be provided on a bottom surface 434 of an outer cylinder block 406, as shown in FIG. 17A, when sealing between the outer cylinder block and the main body cylinder block with liquid sealing material. As a result, when the liquid sealing material 435 is applied to one or both of the mounting surface 424 of the main body cylinder block 404 and the bottom surface 434 of the outer cylinder block 406, and when those surfaces 424 and 434 are abutted together the liquid sealing material 435 is able retain sufficient thickness, as shown in FIG. 17B. Accordingly, an effect is obtained in which the seal durability in a water jacket 450 is improved.

(b) In each of the exemplary embodiments, the outer cylinder block is made of one material selected from the group of a resin, a resin composite, an aluminum alloy, a magnesium alloy, and a ceramic. Alternatively, the outer cylinder block may also be made of a composite in which two or more of these materials are combined. For example, an aluminum alloy layer, a magnesium alloy layer, or a ceramic layer may be formed on the outer peripheral surface of an outer cylinder block made of resin so as to improve resistance against wear and scratches caused by friction from the outside.

(c) In the foregoing exemplary embodiments, the outer cylinder block or the outer cylinder head is positioned with respect to the main body cylinder block or the main body cylinder head by fitting two knock pins into two corresponding positioning holes. The number of holes, however, need not be limited to two, i.e., there may be more than two. Further, a positioning portion other than the combination of the knock pins and positioning holes may be provided. For example, the outer cylinder block or the outer cylinder head may be positioned with respect to the main body cylinder block or the main body cylinder head by matching a concave-convex shape on the bottom surface of the outer cylinder block or the outer cylinder head to a corresponding concave-convex shape on the mounting surface of the main body cylinder block or the main body cylinder head.

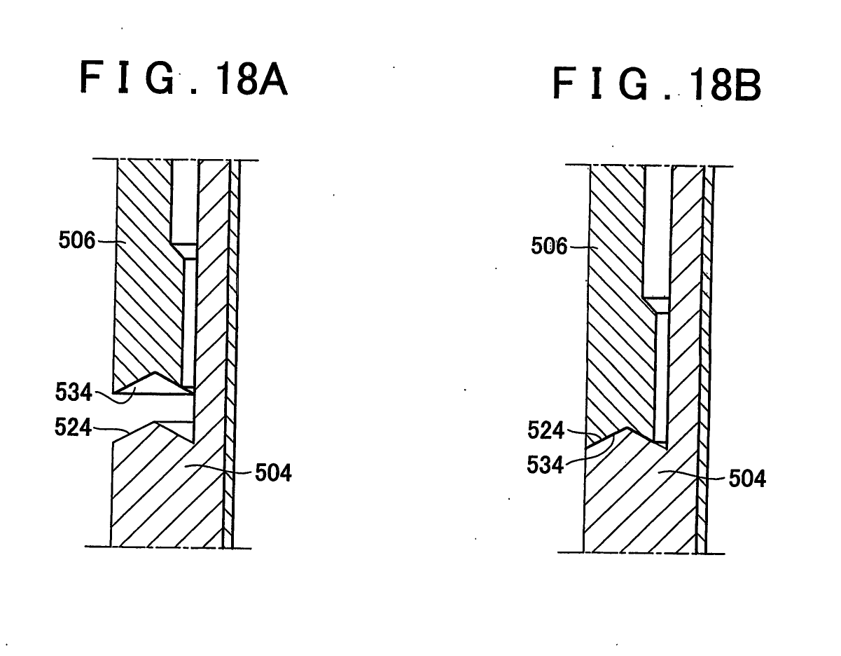

(d) In the foregoing exemplary embodiments, the bottom surfaces of the outer cylinder block and the outer cylinder head, as well as the mounting surfaces corresponding to these, have surfaces perpendicular to the axial direction of the cylinder. Alternatively, however, the bottom surfaces of the outer cylinder block and the outer cylinder head, as well as the mounting surfaces corresponding to these, do not have to have surfaces perpendicular to the axial direction of the cylinder. For example, a mounting surface 524 of a main body cylinder block (or main body cylinder head) 504 may be molded in a cross-sectional triangular projection shape, as shown in FIG. 18A, and a bottom surface 534 of an outer cylinder block (or outer cylinder head) 506 may be molded in a corresponding cross-sectional triangular groove shape. This construction also enables the outer cylinder block (or outer cylinder head) 506 to be positioned with respect to the main body cylinder block (or main body cylinder head) 504 by fitting the mounting surface 524 and bottom surface 534 together, as shown in FIG. 18B. Alternatively, the mounting surface 534 may be molded in the groove shape and the bottom surface 534 may be molded in the projection shape.

(e) In the foregoing exemplary embodiments, liquid sealing material or welding is used to seal between the mounting surface of the main body cylinder block or main body cylinder head, and the bottom surface of the outer cylinder block or outer cylinder head. Alternatively, however, a gasket may be used in place of the liquid sealing material or welding.

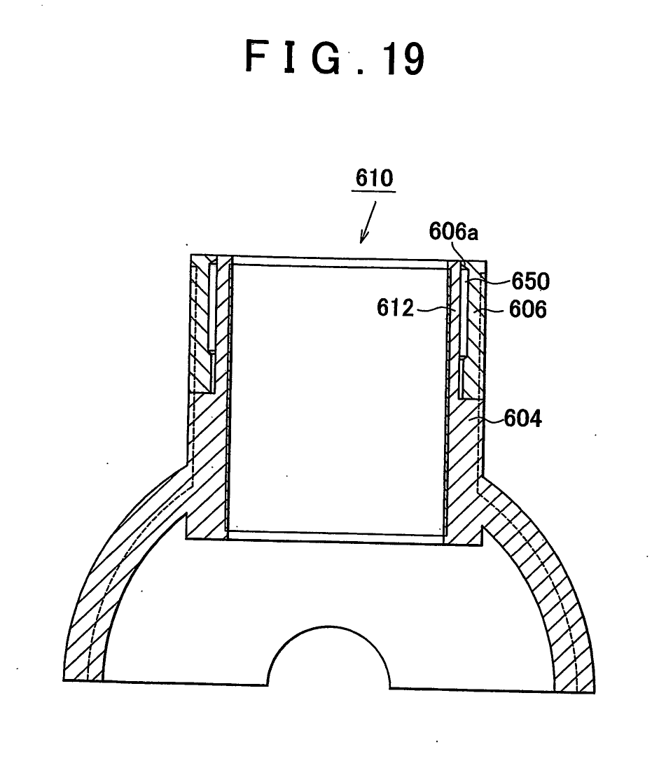

(f) In the foregoing exemplary embodiments, the upper end portion of the main body cylinder block or main body cylinder head is separated from the upper end portion of the outer cylinder block or outer cylinder head, and the water jacket has an open deck prior to assembly of the engine main body. Alternatively, the water jacket may have a closed deck. For example, a projection 606a which projects toward a cylinder 612 side may be provided around the entire periphery on the end of an outer cylinder block 606 such that when a cylinder block 610 is assembled by mounting the outer cylinder block 606 on a main body cylinder block 604, the top end of a water jacket 650 is sealed off, as shown in FIG. 19. The same construction can also be used for the outer cylinder head and the main body cylinder head. Also, the entire periphery along the top end of the water jacket 650 does not have to be entirely closed off, i.e., part of the periphery along the top end may be open.

(g) A bore without a cylinder liner, but to which surface treatment has been applied, as described in the fourth exemplary embodiment of the invention may also be applied to the cylinder described in either the second or third exemplary embodiments. Also, the cylinder may be of cast iron without a cylinder liner.

1-26. (canceled)

27. A cylinder head in which a water jacket is formed around a cylinder top portion, and which, combined with a separate cylinder block, forms an engine main body, the cylinder head comprising:
a main body cylinder head which has a mounting surface and which defines a cylinder top portion side of the water jacket, and
an outer cylinder head which is molded separately from the main body cylinder head as a cylinder head portion which defines a side of the water jacket opposite the cylinder side, the outer cylinder head being arranged in a predetermined position so as to be on the mounting surface of the main body cylinder head so as to define, together with the main body cylinder head, the water jacket, the outer cylinder head to be fixed in place while pressed between the cylinder block and the main body cylinder head while arranged in the predetermined position.

28. The cylinder head according to claim 27, wherein a positioning portion for determining a mounting position of the outer cylinder head with respect to the main body cylinder head is formed on at least one of the main body cylinder head and the outer cylinder head.

29. The cylinder head according to claim 27, wherein the outer cylinder head is formed of a resin or a resin composite.

30. The cylinder head according to claim 27, wherein the outer cylinder head is formed of one or two or more materials selected from the group consisting of an aluminum alloy, a magnesium alloy, a resin, a resin composite, and a ceramic.

31. The cylinder head according to claim 27, wherein the main body cylinder head is molded by casting using an aluminum alloy or a magnesium alloy.

32. An engine main body comprising:
a cylinder block in which a water jacket is formed around a cylinder, and which has a main body cylinder block having a mounting surface and defining a cylinder side of the water jacket and an outer cylinder block; and
a main cylinder head in which the water jacket is formed around a cylinder top portion, and has a mounting surface,
wherein the outer cylinder block which is molded separately from the main body cylinder block and the main body cylinder head as a cylinder block portion which defines a side of the water jacket opposite the cylinder side and the cylinder top portion side, the outer cylinder block being arranged in a predetermined position so as to be between the mounting surface of the main body cylinder block and the mounting surface of the main body cylinder head so as to define, together with the main body cylinder block and the main body cylinder head, the water jacket, the outer cylinder block being fixed in place while pressed between the main body cylinder block and the main body cylinder head while arranged in the predetermined position.

33. The engine main body according to claim 32, wherein a positioning portion for determining a mounting position of the outer cylinder block with respect to the main body cylinder block is formed on at least one of the main body cylinder block and the outer cylinder block.

34. The engine main body according to claim 32, wherein the outer cylinder block is formed of a resin or a resin composite.

35. The engine main body according to claim 32, wherein the outer cylinder block is formed of one or two or more materials selected from the group consisting of an aluminum alloy, a magnesium alloy, a resin, a resin composite, and a ceramic.

36. The engine main body according to claim 32, wherein the main body cylinder block is molded by casting using an aluminum alloy or a magnesium alloy.

37. The engine main body according to claim 36, wherein the main body cylinder block has a cylinder liner cast into a bore portion of the main body cylinder block.

38. The engine main body according to claim 36, wherein a bore portion of the main body cylinder block is surface treated so as to be wear-resistant.

39. The engine main body according to claim 32, wherein the main body cylinder head is molded by casting using an aluminum alloy or a magnesium alloy.

40. The engine main body according to claim 32, wherein the outer cylinder block is fixed between the main body cylinder block and the main body cylinder head with a fastening bolt.

41. The engine main body according to claim 32, wherein sealing material or welding is used to seal between the main body cylinder block and the outer cylinder block.

42. An engine main body comprising the cylinder head according to claim 27 and a cylinder block, the outer cylinder head being fixed between the cylinder block and the main body cylinder head with a fastening bolt.

43. The engine main body according to claim 42, wherein sealing material or welding is used to seal between the main body cylinder head and the outer cylinder head.

44. An engine main body comprising:
a cylinder head according to claim 27; and
a cylinder block in which a water jacket is formed around a cylinder, wherein the cylinder block has a main body cylinder block which has a mounting surface and which defines a cylinder side of the water jacket, and an outer cylinder block which is molded separately from the main body cylinder block as a cylinder block portion which defines a side of the water jacket opposite the cylinder side, the outer cylinder block being arranged in a predetermined position so as to be on the mounting surface of the main body cylinder block so as to define, together with the main body cylinder block, the water jacket, the outer cylinder block to be fixed in place while pressed between the cylinder head and the main body cylinder block while arranged in the predetermined position.

45. The cylinder block according to claim 44, wherein a positioning portion for determining a mounting position of the outer cylinder block with respect to the main body cylinder block is formed on at least one of the main body cylinder block and the outer cylinder block.

46. The cylinder block according to claim 44 wherein the outer cylinder block is formed of a resin or a resin composite.

47. The cylinder block according to claim 34, wherein the outer cylinder block is formed of one or two or more materials selected from the group consisting of an aluminum alloy, a magnesium alloy, a resin, a resin composite, and a ceramic.

48. The cylinder block according to claim 44, wherein the main body cylinder block is molded by casting using an aluminum alloy or a magnesium alloy.

49. The cylinder block according to claim 48, wherein the main body cylinder block has a cylinder liner cast into a bore portion of the main body cylinder block.

50. The cylinder block according to claim 48, wherein a bore portion of the main body cylinder block is surface treated so as to be wear-resistant.

51. A cylinder head in which a water jacket is formed around a top portion of a cylinder, and which forms an engine main body by being combined with a cylinder block provided separately from the cylinder head comprising:
a main cylinder head which defines an inner side surface and a top surface of the water jacket formed in the cylinder head, and which has a fitting surface; and
an outer cylinder head which is molded separately from the main cylinder head, as a portion of the cylinder head, the portion defining an outer side surface of the water jacket formed in the cylinder head, which is fitted on the fitting surface of the main cylinder head so that the outer cylinder head and the main cylinder head form the water jacket in the cylinder head, and which can be pressed between the cylinder block and the main cylinder head while the water jacket in the cylinder head is formed.

52. An engine main body comprising:
a cylinder block in which a portion of a water jacket is formed around a cylinder, which has a main cylinder block and an outer cylinder block, the main cylinder block defining a bottom surface and a part of an inner side surface of the water jacket, and which has a fitting surface; and
a main cylinder head in which the other portion of the water jacket is formed around a top portion of the cylinder, and which defines the other part of the inner side surface and a top surface of the water jacket, and which has a fitting surface,
wherein an outer cylinder block which is molded separately from the main cylinder block and the main cylinder head, as a portion of the cylinder block, the portion defining an outer side surface of the water jacket, which is fitted between the fitting surface of the main cylinder block and the fitting surface of the main cylinder head so that the outer cylinder block, the main cylinder block, and the main cylinder head form the water jacket, and which can be pressed between the main cylinder block and the main cylinder head while the water jacket is formed.
